(19) United States
(12) Patent Application Publication
(10) Pub. No.: US 2014/0229222 A1
(43) Pub. Date: Aug. 14, 2014

(54) INTEGRATED PROJECT PLANNING AND MANAGEMENT APPLICATION

(71) Applicant: Sadaf Shakil, Bangalore (IN)

(72) Inventor: Sadaf Shakil, Bangalore (IN)

(21) Appl. No.: 13/833,439

(22) Filed: Mar. 15, 2013

(30) Foreign Application Priority Data
Feb. 8, 2013 (IN) 549/CHE/2013

(51) Int. Cl. G06Q 10/06

(52) U.S. Cl. CPC G06Q 10/06313
USPC 705/7.23

(57) ABSTRACT

To generate a plan for executing a project, the project is selected in an integrated project planning and management from a database. Based on the selected project, enterprise project data elements associated with the project are retrieved from the database. The retrieved enterprise project data elements are displayed on a first user interface associated with the integrated project planning and management application. On the first user interface, an enterprise project data element is selected and a planning model associated with the integrated project planning and management application is activation to instantiate a second user interface. The second user interface displays data corresponding to the selected enterprise project data element. The second user interface receives an input to modify the displayed data corresponding to the selected enterprise project data element. The plan for executing the selected project is generated based on the modified data corresponding to the enterprise project data element.

This application claims priority to an Indian Provisional Patent Application serial No: 549/CHE/2013, titled: “INTEGRATED ERP BASED PLANNING AND PROJECT MANAGEMENT”, filed on Feb. 8, 2013, which is hereby incorporated by reference.

### BACKGROUND

Corporate entities and enterprises use project management applications for managing projects. The project management applications may be implemented on a general purpose computer or a server that may be physically residing on premises of the enterprise. In addition to the project management application, heterogeneous standalone planning or data processing applications may be used to schedule or generate a plan of execution for the projects.

Using heterogeneous standalone applications for project planning and project management may lead to generation of inconsistent data as the applications may work with different file formats. Inconsistent data and dissimilar formats may further lead to data redundancy and operational complexity. In such situations, end users have to be aware of attributes associated with use of various heterogeneous applications, to achieve an objective of planning and management of the projects. Hence, there is a need for systems and methods to provide a common platform for heterogeneous applications involved in planning and managing projects.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a system for generating an execution plan for a project, according to an embodiment.

FIG. 2 is a flow diagram illustrating a method for generating an execution plan for a project, according to an embodiment.

FIG. 3 is a block diagram illustrating a system to generate an execution plan for a project, according to an embodiment.

FIG. 4A is an exemplary illustration of a first user interface of an integrated project planning and management application, according to an embodiment.

FIG. 4B is an exemplary illustration of a first user interface and a second user interface of the integrated project planning and management application, according to an embodiment.

FIG. 5A is an exemplary illustration of a first user interface and a second user interface of an integrated project planning and management application, according to an embodiment.

FIG. 5B is an exemplary illustration of a first user interface and a second user interface of an integrated project planning and management application, according to an embodiment.

FIG. 6 is an exemplary illustration of a first user interface and a second user interface of an integrated project planning and management application, according to an embodiment.

FIG. 7 is a block diagram of an exemplary computer system.

### DETAILED DESCRIPTION

Embodiments of techniques for integrated project planning and management application are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Technological advancements have propelled a demand for standalone integrated project planning and management systems that provide objectives of project planning and management of the projects. These project planning and management systems may include applications integrated with conventional enterprise resource planning (ERP) framework. In an embodiment, the ERP framework includes systems and applications to manage flow of information across diverse functional processes of the enterprise. This data may reside in a database that is centrally accessed using standalone or integrated applications over the ERP framework. The data includes information associated with the diverse functional processes of the enterprise including project information that may be currently under execution or may be pipelined for execution in the near future, etc. The systems in the ERP framework may include general purpose computers communicatively coupled to each other over a network. These general purpose computers may further implement customized software packages as applications to achieve operational objectives for each functional process of the enterprise.

The diverse functional processes of the enterprise includes financial accounting division for planning and managing finances for the enterprise; a supply chain management division for planning and managing inventory for the enterprise, and the like; a customer relation management (CRM) division for managing current and prospective customers and clients of the enterprise; an engineering services division that provides customized on-demand engineering services, and the like; a human resources division to manage the human capital of the enterprise and the like, etc. These processes execute defined processes and functionalities to achieve the operational objectives for the enterprise.

For instance, the human resources division handles functionalities related to management of human capital for the enterprise including work breakdown tasks, for example, employee recruiting, employee training and development, managing diversity, retirements, separations, etc. Each work breakdown task may be planned and managed efficiently to achieve the objectives associated with the human resources division. Hence the end-users of the human resources division may use an integrated project planning and management system including integrated applications to plan and manage the functionalities. The integrated project planning and management system may prevent the user from using multiple heterogeneous standalone systems for managing and planning projects.

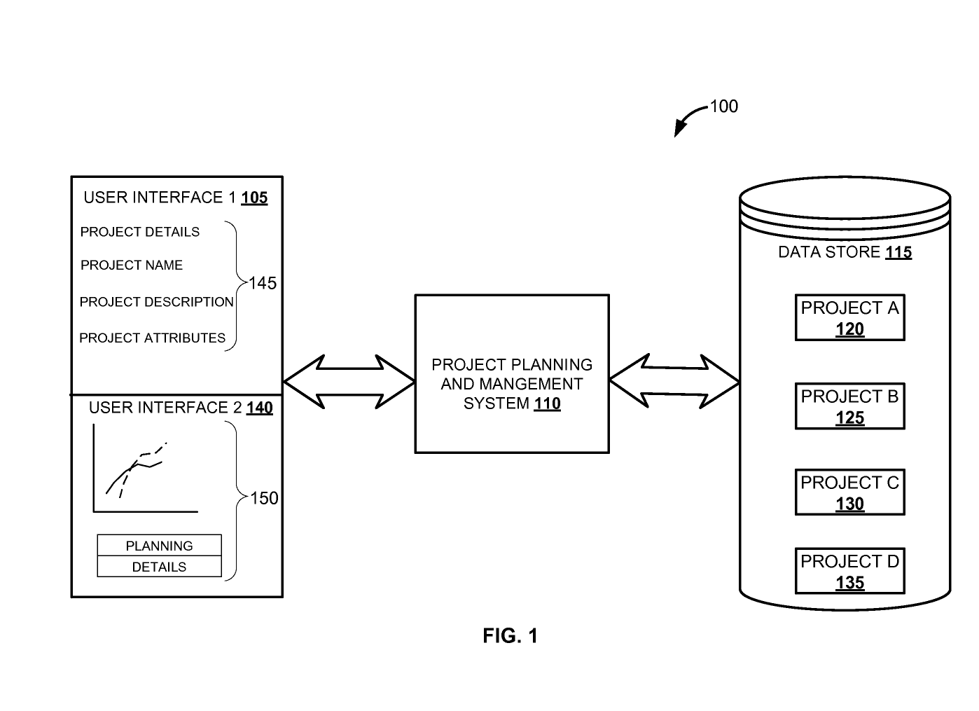

FIG. 1 is a block diagram illustrating a system for generating an execution plan for a project, according to an embodiment. The block diagram 100 illustrates a project planning and management system 110 communicatively coupled to a database 115 over a network (not shown). The project planning and management system 110 includes an integrated project planning and management application (IPMA), wherein a project management engine is integrated with a planning engine. The project management engine is operable to work in conjunction with the planning engine. Hence the project planning and management system 110 provides integrated solution for managing and planning projects. In an embodiment, the project management engine is a web based application (for e.g. an enterprise project management application) and the planning engine is a data processing application (for e.g. a word processing application, a spreadsheet application, and the like). In another embodiment, the project management engine instantiates project management application or a web based project management application and the planning engine instantiates a planning application or a data processing application.

In an embodiment, the data store 115 stores data including information related to the enterprise. The data store 115 may include a database, an in-memory database, an operational data store, a web based data service, or the like containing structured and unstructured data. This data includes information related to projects 120, 125, 130, 135 associated with diverse functional processes of the enterprise. The projects may be currently under execution or may be pipelined for execution in the near future, etc. The information may be stored in the data store 115 in different formats for example, tables, charts, spreadsheets, customized data formats accessible by the applications, and the like. For instance, the data related to employee recruiting includes information related to number of positions available for recruitment for each line of business associated with the enterprise, an estimate of financial information for each line of business, or the like.

In an embodiment, the project planning and management system 110 generates a unique index corresponding to the projects 120, 125, 130, 135 stored in the data store 115 to uniquely identify each of the projects. The project planning and management system 110 includes a first access interface, for example a first user interface (UI) 105. The first UI 105 receives a user selection of the project in the project planning and management system 110 residing in the data store 115. Based on the unique index, the project management engine of the project planning and management system 110 retrieves the associated data and displays it on the first UI 105. The data displayed on the first UI 105 includes project details 145 including project header information and one or more enterprise project data elements associated with the project. The user may select the enterprise project data element to generate a plan for the project. The user may generate a new plan or modify an existing plan for the selected enterprise project data element. The plan for the selected enterprise project data element may be generated or modified by activating the planning engine of the integrated with the project planning and management system 110.

Based upon the received activation, the planning engine instantiates a second UI, for example a spreadsheet workbook 140. The data corresponding to the selected enterprise project data element that needs to be planned is displayed in the spreadsheet workbook 140. The data displayed in the spreadsheet workbook 140 includes detailed resource and planning information 150 represented in multiple cells arranged as rows and columns. The spreadsheet workbook 140 also includes graphical illustrations corresponding to the data of the enterprise project data element. In an embodiment, the spreadsheet workbook 140 receives a user input to modify the data corresponding to the enterprise project data element. This modified data is stored in the data store 115 and is used to generate the plan for executing the project.

For example, the task of employee recruiting may need to be planned based on the human capital requirements for the enterprise. The task of employee recruiting may include enterprise project data elements like pre-screening prospective candidate profiles, scheduling interviews, coordinating with members of interview panel based on their availability, and the like. Each enterprise project data element needs to be planned to ensure that the task of employee recruiting is accomplished efficiently. The end users scheduling and managing the process of recruiting may use project planning and management system including IPMA. In an embodiment, the term “integrated” may refer to an aggregation of disparate applications, for example the planning or the data processing application with the project management application. The IPMA includes a first UI 105. The information associated with the projects including the enterprise project data elements may be accessed by a user via the first UI 105. The user selects the project 120, 125, 130, 135 stored in the data store 115 via the first UI 105.

Based on the selected project, the IPMA retrieves information 145 including the enterprise project data elements and displays it on the first UI 105. The user selects the enterprise project data element that needs to be planned via the first UI and activate business logic, for example a planning model, associated with the IPMA. Upon activating the planning model, a spreadsheet workbook 140 is instantiated. The spreadsheet workbook 140 displays data 150 including graphical illustrations corresponding to the selected enterprise project data element. The spreadsheet workbook 140 may receive inputs from the user to modify the data 150 corresponding to the enterprise project data element. The modifications to the data may include addition of new information, deletion of information, updating rows or columns with additional information, and the like. The modified data may be saved to the data store in a user-defined format or a default format. The default format may be configured by the IPMA.

Based on the modified data saved in the data store, a plan of execution for the enterprise project data element employee recruiting may be generated. In another embodiment, the spreadsheet workbook 140 may include embedded input ready queries. The user may select variables associated with the input ready queries to generate the plan for the enterprise project data element. In an embodiment, the spreadsheet workbook 140 may perform data analysis, store user defined formulas, macro procedures, receive insertion, modification, deletion, etc. of worksheets; generate charts and visualizations based on the data corresponding to the enterprise project data element.

In an embodiment, multiple users may use the project planning and management system 110 to generate plans of execution for multiple enterprise project data elements associated with the project. For example, multiple users can simultaneously generate plans for enterprise project data elements employee recruiting, employee training and development, etc. The spreadsheet workbook 140 including the plan data 150 may be linked to the project and saved in the data store 115.

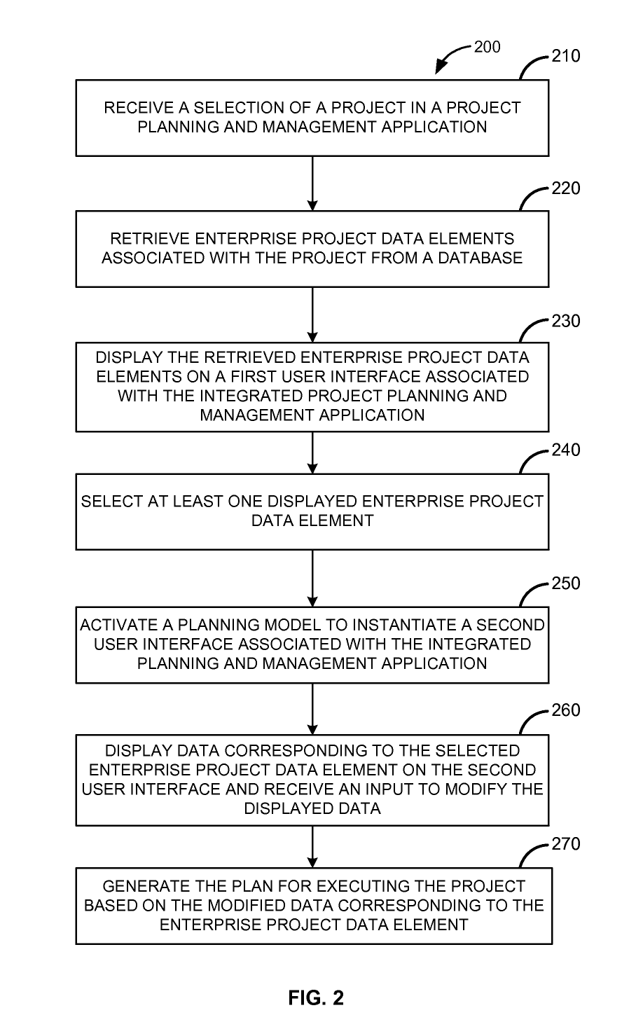

FIG. 2 is a flow diagram illustrating a method for generating an execution plan for a project, according to an embodiment. In an embodiment, a user generating an execution plan for a project selects the project in an IPMA from a data store, at process block 210. Based on the selected project, enterprise project data elements associated with the project are retrieved from the data store, at process block 220. The retrieved enterprise project data elements are displayed on a first user interface associated with the IPMA, at process block 230. At least one the displayed enterprise project data element is selected, at process block 240. A planning model is activated to instantiate a second user interface associated with the IPMA, at process block 250. The instantiated second user interface displays data corresponding to the selected enterprise project data element and receives input to modify the data corresponding to the enterprise project data element, at process block 260. The plan for executing the selected project is generated based on the modified data corresponding to the selected enterprise project data element, at process block 270.

In an embodiment, the IPMA includes a reporting model, and a forecasting model. The reporting model includes tools, data processing routines, algorithms and models to generate advanced reporting solutions. The forecasting model includes advanced tools, algorithms and advanced data processing models to generate forecasting solutions based on the business data associated with the processes of the enterprise. Graphical illustrations and visualizations may be generated for the results of analysis, linked to the projects and stored in the data store. The graphical illustrations and the data including past and present information may be used to generate forecasting information for the enterprise.

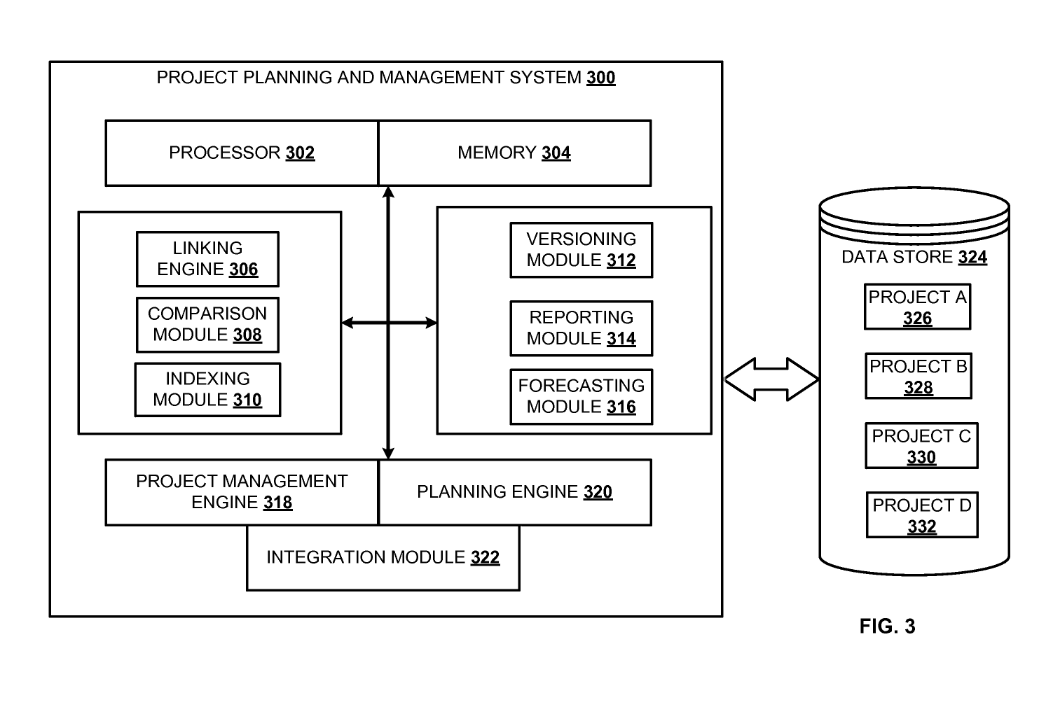

FIG. 3 is a block diagram illustrating a system to generate an execution plan for a project, according to an embodiment. In an embodiment, a project planning and management system 300 is communicatively coupled to a data store 324 over a network (not shown). The data store 324 stores data including information related to the enterprise. This information includes data from diverse functional processes of the enterprise, including projects 326, 328, 330, 332 that may be currently under execution or may be pipelined for execution in a near future, etc. In an embodiment, the project planning and management system 300 includes a processor 302 and a memory 304 communicatively coupled to a project management engine 318, a planning engine 320, a linking engine 306, a comparison module 308, a forecasting module 316, a reporting module 314, an indexing module 310, a versioning module 312 and an integration module 322. The above engines 306, 318, 320 and modules 308, 312, 314, 316 and 322 in the project planning and management system 300 work in conjunction with the other to achieve an objective of planning and managing project for the enterprise.

In an embodiment, the linking engine 306 links the data corresponding to the enterprise project data elements with the projects. For instance, the plan data associated with an enterprise project data element may be saved in a spreadsheet workbook. The linking engine 306 is configured to track this information and link the spreadsheet workbooks to the projects. The versioning module 312 generates a unique version for each plan data associated with the enterprise project data elements. For instance, each time the data corresponding to the enterprise project data element is modified and stored in the data store 324, the associated planning data is saved in the data store 324 as a new version. For example, USER A may generate a first plan for the enterprise project data element “employee recruiting”. USER B may modify the data corresponding to the enterprise project data element “employee recruiting” to generate a second plan. Here, the versioning information of plan generated by USER A is referenced as “Version 1”; and the versioning information of plan generated by USER B is referenced as “Version 2”.

In an embodiment, the versioning module 312 automatically generates the version information for each instance of modified data associated with the enterprise project data element and saves this version information in the data store 324. The comparison module 308 is configured to maintain a repository in the data store that generates a history of modified data associated with the enterprise project data element. The history may be referenced to track the data modifications and hence compare the plan versions using the comparison module. The indexing module 310 generates a unique index corresponding to the projects stored in the data store. The unique index enables quicker retrieval of data, including the enterprise project data elements associated with the selected projects. The forecasting module 314 is configured to generate forecasting information including graphical illustrations. The forecasting module includes algorithms, routines, procedures, statistical models, mathematical models, or the like, related business intelligence, artificial intelligence, etc. The forecasting module 316 generates forecasting reports based on the data associated with the projects. The reporting module 314 is configured to generate reports based on the data associated with the projects.

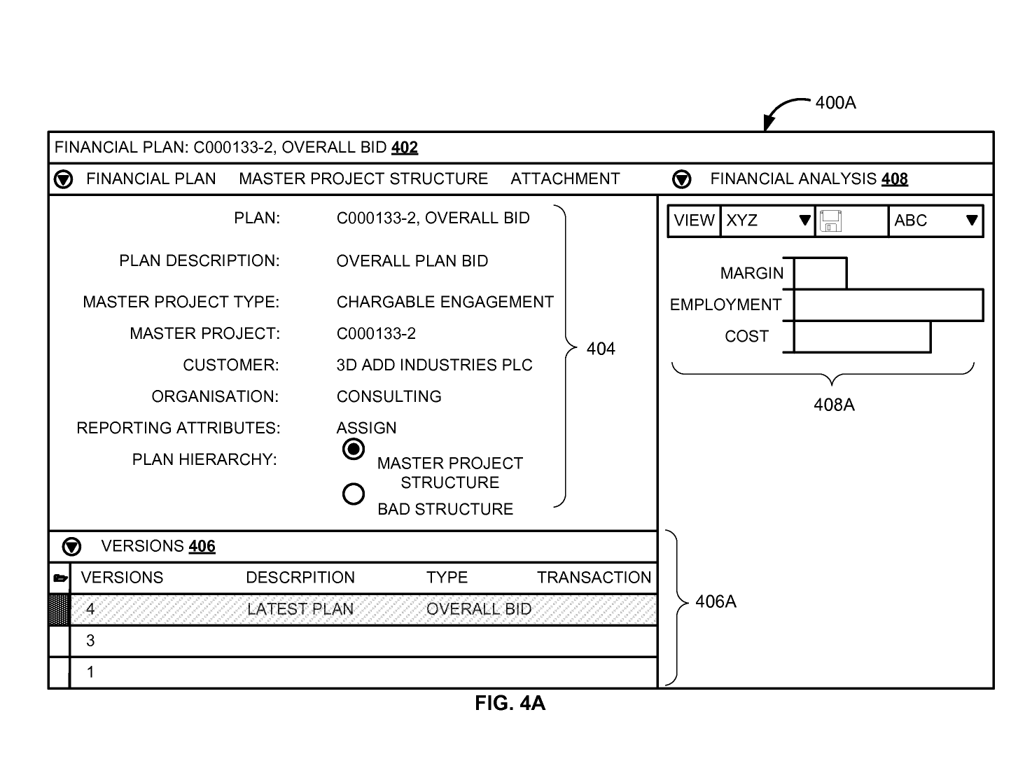

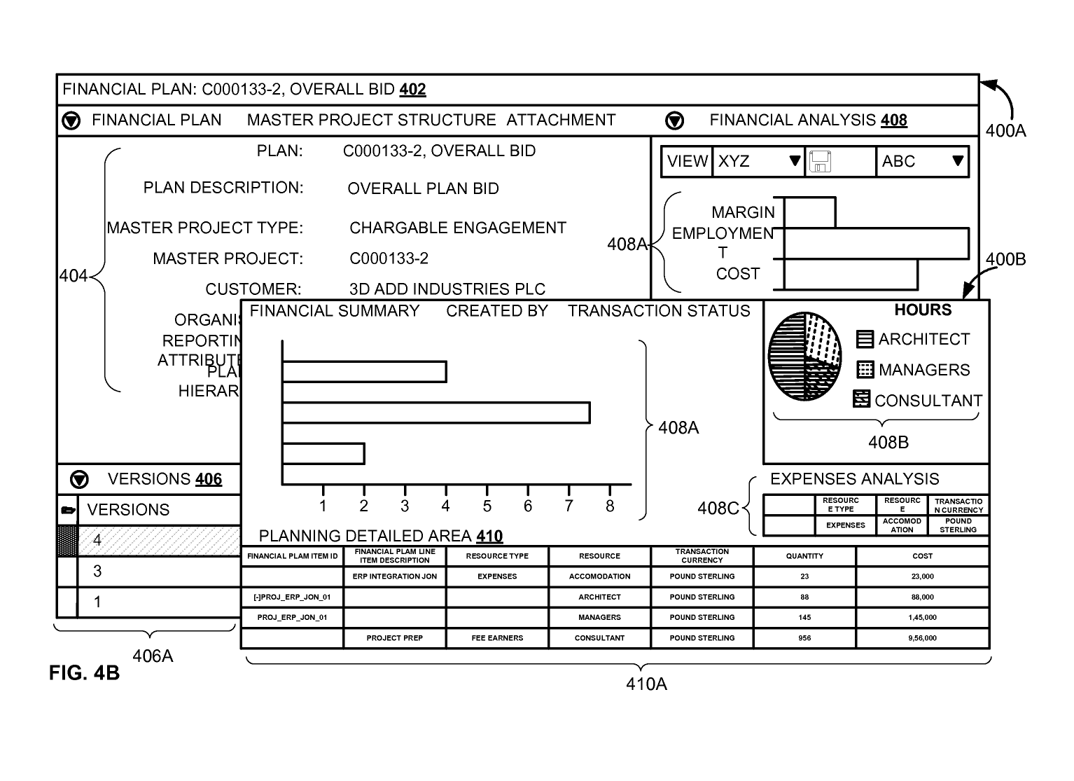

FIG. 4A is an exemplary illustration of a first user interface of an integrated project planning and management application, according to an embodiment. In an embodiment, a project is selected in an IPMA via a first user interface (UI) 400A. Upon receiving the selection, the project management engine 318 of the IPMA retrieves data including enterprise project data elements from a data store 324 and displays it on the first UI 400A. The data displayed may include project information including plan header details, enterprise project data elements, and the like (not shown). As exemplarily illustrated in FIG. 4A, the first UI 400A displays data corresponding to the enterprise project data element “FINANCIAL PLAN.” 402 including plan header information 404 (for e.g. Plan Id, Plan Description, Master Project Type, Master Project, Customer, Organization, Reporting Attributes, Plan Hierarchy, etc.) plan versions 406, 406A and the like. The plan versions 406 enlist all previously versions of generated plans 406A for the enterprise project data element “FINANCIAL PLAN” 402. Further the first UI 400A displays information related to “FINANCIAL ANALYSIS” 408 and the associated graphical illustration 408A.

FIG. 4B is an exemplary illustration of a first user interface and a second user interface of an integrated project planning and management application, according to an embodiment. As exemplarily illustrated in FIG. 4A, data including information related to the “FINANCIAL PLAN” 402 and version information 406 is retrieved from the data store 324 by the project management engine 318 of the IPMA. The retrieved data is displayed on the first UI 400A. A user may generate a new plan or select an existing version of the plan to modify it. For instance, the user selects the plan with version information ‘4’ and description “LATEST PLAN” and triggers it. Based on the received trigger, the planning engine 320 of the IPMA instantiates a second user interface (UI), for example a spreadsheet workbook 400B. The spreadsheet workbook 400B displays the data corresponding to the “FINANCIAL PLAN” 402.

As exemplarily illustrated in FIG. 4B, the spreadsheet workbook 400B includes data corresponding to the “FINANCIAL PLAN” 402 including information related to “FINANCIAL SUMMARY”, the user who generated the plan, transaction status, expense analysis 408C, and graphical illustration 408A for the “FINANCIAL PLAN” 402. The spreadsheet workbook 400B receives input to modify the data corresponding to the “FINANCIAL PLAN” 402. The information corresponding to the displayed data “PLANNING DETAILED AREA” 410 includes detailed plan information associated with the “FINANCIAL PLAN” 402 represented in multiple cells arranged in rows and columns 410A. This information may be modified and the spreadsheet workbook 400B is saved in the data store 324 to generate a new plan for the “FINANCIAL PLAN” 402.

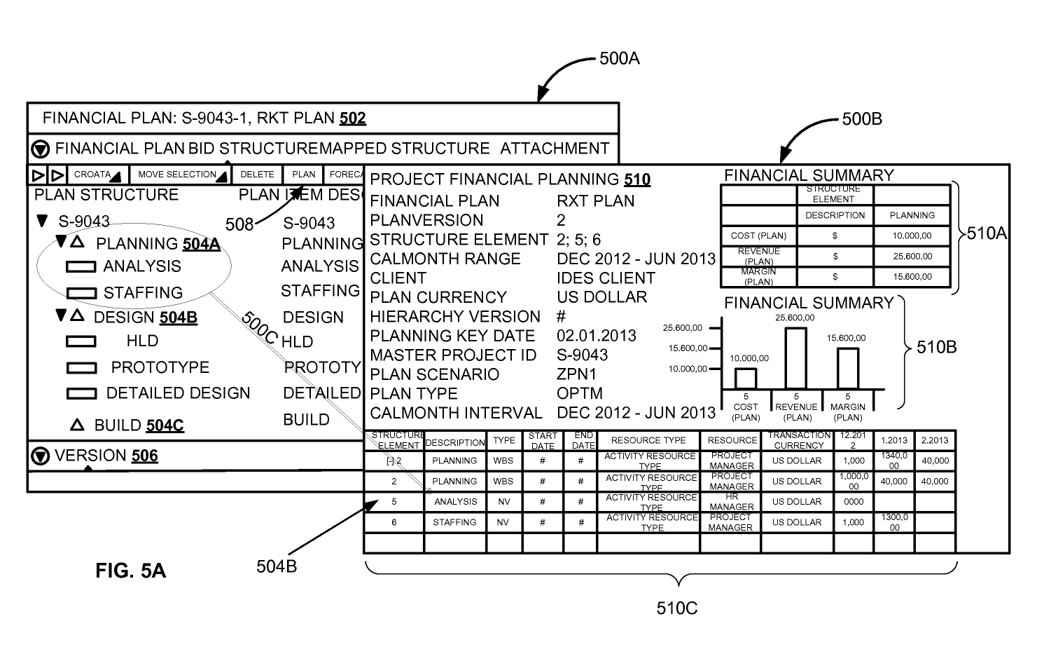

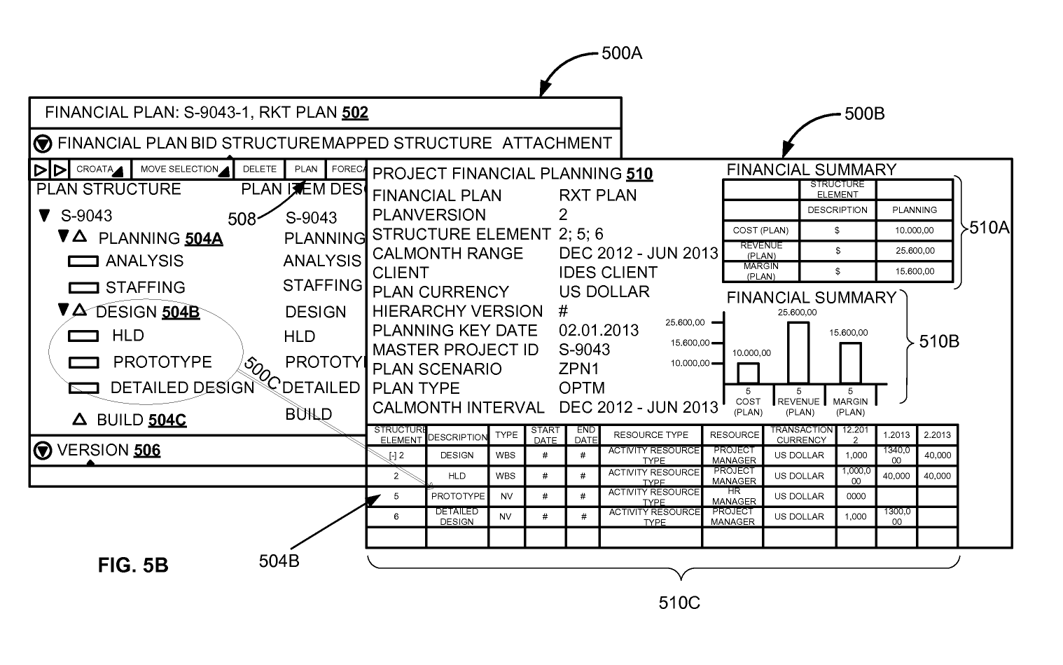

FIG. 5A is an exemplary illustration of a first user interface and a second user interface of an integrated project planning and management application, according to an embodiment. In an embodiment, a first UI 500A of the IPMA displays “PLAN STRUCTURE” for the enterprise project data element “FINANCIAL PLAN” 502. The “PLAN STRUCUTURE” includes information related to “PLANNING” element 504A, “DESIGN” element 504B, “BUILD” element 504C, etc. The “PLANNING” element 504A includes information related to sub-elements “ANALYSIS” and “STAFFING”; the “DESIGN” element includes information related to sub-elements “HIGH LEVEL DESIGN”, “PROTOTYPE”, “DETAILED DESIGN”, etc.

As exemplarily illustrated in FIG. 5A, the planning engine 320 of the IPMA is activated 508 to instantiate the second UI, for example the spreadsheet workbook 500B. The spreadsheet workbook 500B displays data corresponding to the “PLANNING” element 504A on the spreadsheet workbook 500B, indicated by arrow 500C. The data corresponding to the “PLANNING” element 504A includes information related to the sub-elements “ANALYSIS” and “STAFFING” 510C including “FINANCIAL SUMMARY” illustrated graphically 510B or alternatively, in tabular form 510A, planning header information associated with the “FINANCIAL PLAN” 502, etc. The spreadsheet workbook 500B receives input from the user and the data corresponding to the “FINANCIAL PLANNING” 510 may be modified and saved in the data store 324 to generate a plan for the “FINANCIAL PLAN” 502.

FIG. 5B is an exemplary illustration of a first user interface and a second user interface of an integrated project planning and management application, according to an embodiment. As explained in detailed description of FIG. 5A, a plan may be generated for the “DESIGN” element 504B. The corresponding data is displayed in the spreadsheet workbook 500B, as indicated by arrow 500C. In an embodiment, multiple users may generate the plans for the elements associated with the project. For example, as exemplarily illustrated in FIG. 5B, USER A may generate a plan for the “PLANNING” element 504A; USER B may generate a plan for the “DESIGN” element 504B; USER C may generate a plan for the “BUILD” element 504C. The data corresponding to the above elements 504A, 504B, 504C may be modified simultaneously by the respective users. In an embodiment, the element that is modified may not accessible to other users. For example, if the data corresponding to the “PLANNING” element 504A is modified by USER A, then the “PLANNING” element 504A may be locked from access to USER B or USER C. However, USER B or USER C may have access to the “DESIGN” element 504B or “BUILD” element 504C. USER B or USER C may simultaneously modify the data corresponding to the “DESIGN” element 504B or “BUILD” element 504C, while USER A is modifying the data corresponding to the “PLANNING” element 504A. For each .element 504A, 504B, 504C, the corresponding spreadsheet workbook receives input from the users and the data corresponding to the “FINANCIAL PLANNING” 510 may be modified and saved in the data store 324 to generate a plan for the “FINANCIAL PLAN” 502.

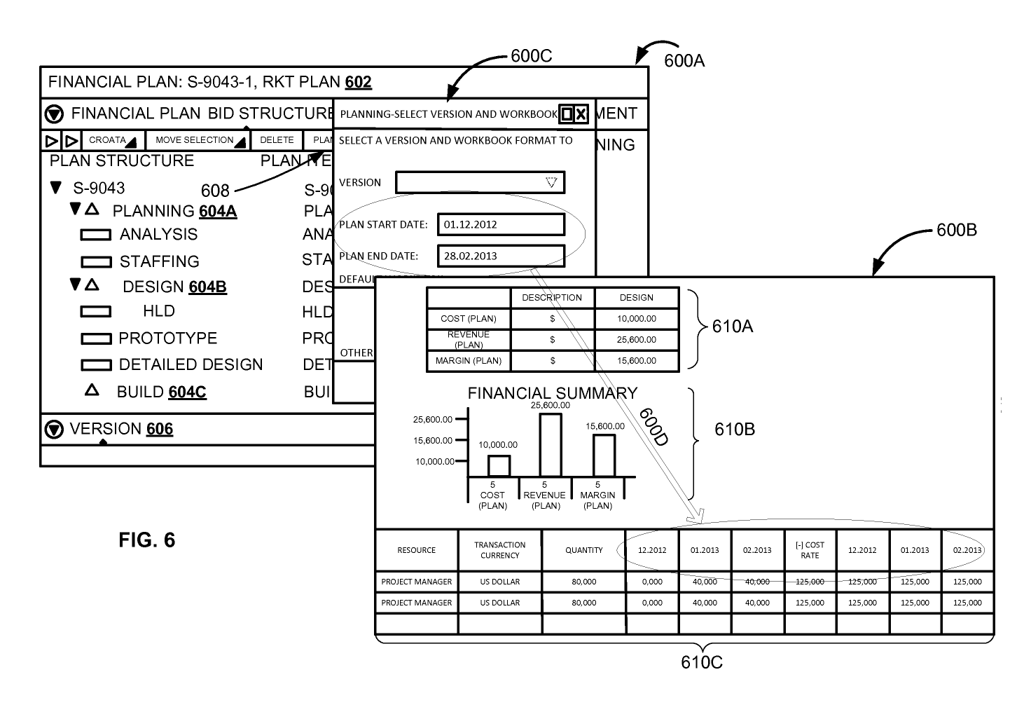

FIG. 6 is an exemplary illustration of a first user interface and a second user interface of an integrated project planning and management application, according to an embodiment. In an embodiment, a first UI 600A of the IPMA includes a sub user interface element 600C. The sub UI element 600C receives an input that may include a version number, and/or plan start date, plan end date, etc. Based on the received input, the planning engine 320 of the IPMA instantiates a spreadsheet workbook 600B and displays filtered data associated with the enterprise project data element. As exemplarily illustrated in FIG. 6, the first UI 600A displays the data corresponding to the enterprise project data element “FINANCIAL PLAN” 602 including a sub UI element 600C to receive the inputs corresponding to Plan Start Date and Plan End Date. Based on the received input, the planning engine 320 of the IPMA instantiates the spreadsheet workbook 600B and displays filtered data in the spreadsheet workbook 600B. As exemplarily illustrated in FIG. 6, the spreadsheet workbook 600B displays filtered data corresponding to Plan Start Date “01.12.2012” and Plan End Date “28.02.2013”, indicated by arrow 600D. In an embodiment, the spreadsheet workbook may receive a user input to modify the data associated with the “FINANCIAL PLAN” 602 and the spreadsheet workbook 600B including the modified data may be saved in the data store 324 and generate the execution plan for the “FINANCIAL PLAN” 602.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

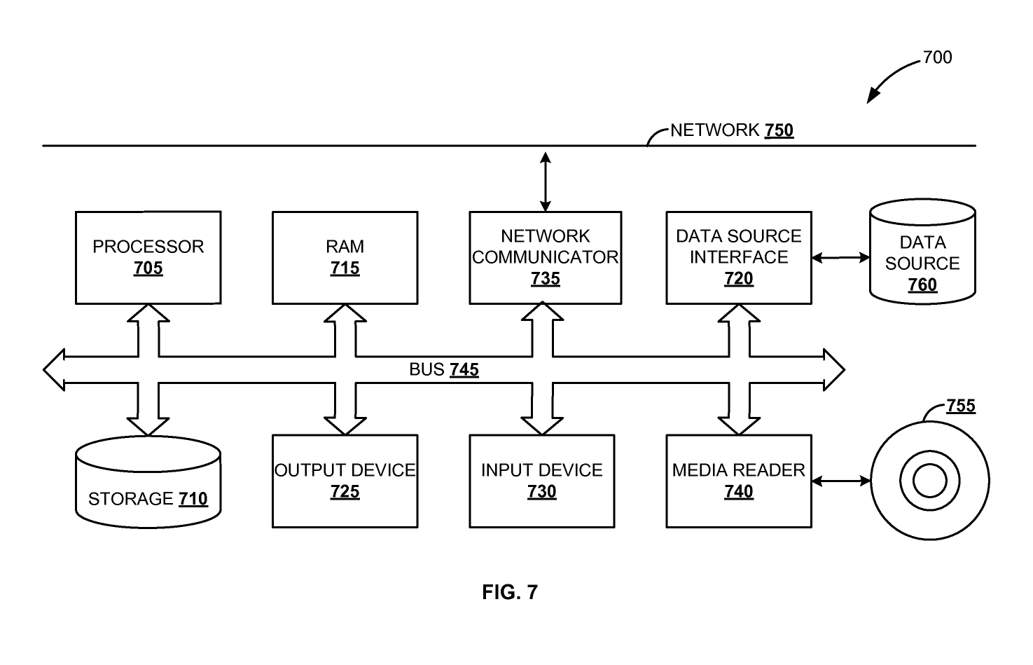

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, all of the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to generate a plan to execute a project, comprising:
receiving a selection of a project in an integrated project planning and management application;
based on the selected project, retrieving one or more enterprise data elements associated with the project from a data store, and displaying the retrieved enterprise project data elements on a first user interface associated with the integrated project planning and management application;
receiving a selection of at least one of the displayed enterprise project data element and activating a planning engine of the integrated project planning and management application to instantiate an associated second user interface;
displaying data corresponding to the selected enterprise project data element within the instantiated second user interface;
receiving an input to modify the displayed data corresponding to the enterprise project data element; and
generating the plan to execute the selected project based on the modified data corresponding to the enterprise project data element.

2. The computer implemented method of claim 1, further comprising: saving the modified data corresponding to the selected enterprise project data element in a user-defined format in the data store.

3. The computer implemented method of claim 1, further comprising: generating a unique index corresponding to the project stored in the database.

4. The computer implemented method of claim 1, wherein the second user interface includes a spreadsheet workbook operable to embed user defined functions chosen from a group including input ready queries, macro procedures, and a combination thereof.

5. The computer implemented method of claim 4, wherein the spreadsheet workbook includes the data corresponding to the enterprise project data element, one or more graphical illustrations, and a combination thereof.

6. The computer implemented method of claim 1 further comprising:
a reporting model to generate advanced reporting solutions; and
a forecasting model to generate forecasting information for an enterprise.

7. An article of manufacture including a non-transitory computer readable storage medium to tangibly store instructions, which when executed by a computer, cause the computer to:
receive a selection of a project in an integrated project planning and management application;
based on the selected project, retrieve one or more enterprise project data elements associated with the project from a data store and display the retrieved enterprise project data elements on a first user interface associated with the integrated project planning and management application;
receive a selection of the at least one displayed enterprise project data element and activate a planning model to instantiate an associated spreadsheet workbook;
display data corresponding to the selected enterprise project data element within the instantiated spreadsheet workbook;
receive an input to modify the displayed data corresponding to the enterprise project data element; and
generate the plan to execute the project based on the modified data corresponding to the enterprise project data element.

8. The article of manufacture of claim 7, wherein the project management engine is a web based project management engine integrated with the planning engine.

9. The article of manufacture of claim 7, further comprising: generate an index corresponding to the project stored in the database.

10. The article of manufacture of claim 7, further comprising: saving the modified data corresponding to the selected enterprise project data element in a user-defined format in the database.

11. The article of manufacture of claim 7, wherein the second user interface includes a spreadsheet workbook operable to embed user defined functions chosen from a group including input ready queries, macro procedures, and a combination thereof.

12. A computer implemented system to generate a plan to execute a project, comprising:
a processor operable to read and execute instructions stored in one or more memory elements;
a user input device to select a project stored in a data store;
a project management engine to retrieve one or more enterprise project data elements from the data store based on the selected project;
an output device to display the retrieved enterprise project data elements on a first user interface;
the user input device to select the at least one displayed enterprise project data element and activate a planning engine to instantiate a second user interface;
the output device to display the data corresponding to the selected enterprise project data element on the second user interface;
the user input device to modify the displayed data corresponding to the selected enterprise project data element;
the one or more memory elements storing instructions related to:
generating the plan to execute the project, based on the modified data corresponding to the selected enterprise project data element.

13. The computer implemented system of claim 13, further comprising: an indexing module to generate a unique index corresponding to the project stored in the data store.

14. The computer implemented system of claim 13, further comprising: an integration module to integrate the project management engine with the planning engine.

15. The computer implemented system of claim 13, further comprises: a versioning module to generate unique version information for each instance of modified plan data associated with the selected enterprise project data element.

16. The computer implemented method of claim 13, further comprising: a linking engine to link the data including information associated with the enterprise project data element with the project.

17. The computer implemented system of claim 13, further comprising: a comparison module to compare the versions of the plans associated with enterprise project data elements of the project.

18. The computer implemented system of claim 13, further comprising: a reporting module to generate reports based on the data associated with the projects.

19. The computer implemented system of claim 13, further comprising: a forecasting module to generate forecasting information based on the data associated with the projects.

20. The computer implemented system of claim 13, wherein the second user interface includes a spreadsheet workbook operable to embed user defined functions chosen from a group including input ready queries, macro procedures, and a combination thereof.
